(19) United States
(12) Patent Application Publication
(10) Pub. No.: US 2015/0373787 A1
(43) Pub. Date: Dec. 24, 2015

(54) APPARATUS AND METHOD FOR DUAL MODE TEMPERATURE SENSING

(71) Applicant: CookTek Induction Systems, LLC, Chicago, IL (US)

(72) Inventors: Robert J. Visher, Downers Grove, IL (US); Reinhard Metz, Wheaton, IL (US); Warren S. Graber, Hoffman Estates, IL (US)

(21) Appl. No.: 14/745,960

(22) Filed: Jun. 22, 2015

Related U.S. Application Data
(60) Provisional application No. 62/015,755, filed on Jun. 23, 2014.

(51) Int. Cl. H05B 6/06; H05B 6/12

(52) U.S. Cl. CPC H05B 6/062; H05B 6/1209

(57) ABSTRACT

An inductive cooking system including a non-ferromagnetic cooking surface; an induction coil disposed adjacent to the cooking surface; a contact-based temperature sensing device thermally coupled to the cooking surface; and a non-contact temperature sensing device positioned to collect heat energy from an underside of the cooking surface.

### CROSS-REFERENCE TO RELATED APPLICATIONS

This application claims priority to U.S. Provisional Application Ser. No. 62/015,755, the entire contents of which are hereby incorporated by reference.

### BACKGROUND

The present invention relates to temperature sensing in inductive cooking systems.

### SUMMARY

In one embodiment, the invention provides an inductive cooking system including a non-ferromagnetic cooking surface; an induction coil disposed adjacent to the cooking surface; a contact-based temperature sensing device thermally coupled to the cooking surface; and a non-contact temperature sensing device positioned to collect heat energy from an underside of the cooking surface.

In another embodiment the invention provides a method of inductive cooking using an inductive cooking system. The inductive cooking system includes a non-ferromagnetic cooking surface and an induction coil disposed adjacent to the cooking surface. The method includes the steps of obtaining a measurement from a contact-based temperature sensing device thermally coupled to the cooking surface; and obtaining a measurement from a non-contact temperature sensing device positioned to collect heat energy from an underside of the cooking surface.

Other aspects of the invention will become apparent by consideration of the detailed description and accompanying drawings.

### BRIEF DESCRIPTION OF THE DRAWINGS

FIGS. 1a and 1b show IR transmission curves for ceramitized glass.

FIG. 2 shows a diagram of a dual mode temperature sensing system.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Induction cooking systems may use contact-based temperature sensing mechanisms or infrared temperature sensing mechanisms. Each mechanism alone has certain drawbacks, as discussed below.

After a period of time has elapsed during a typical warming or cooking cycle on an induction cooktop, and particularly at temperatures below 250° F., the cooking vessel (e.g. a pan) and the glass cooking surface reach a thermal equilibrium provided there is sufficient physical contact between the pan and glass. This allows for relatively accurate temperature measurement of the pan by using a contact temperature sensor such as a resistive temperature device (RTD), placed in physical contact with the ceramitized glass, as a temperature sensor. The RTD measures the temperature of the glass, which accurately reflects the temperature of the pan provided that the pan has sufficient contact with the glass. Thus, one approach that may be used to monitor the temperature of a pan in an induction heating system may be using an RTD sensor alone. Nevertheless, this approach has several potential drawbacks:
A lag exists in measurement time as thermal energy from the pan must heat the glass by conduction and raise the glass temperature before it can be measured;
An additional lag of as much as 10-15 seconds exists, after the glass reaches a particular temperature, due to the response time of the contact-based temperature sensing device (e.g. the RTD);
The pan must be extremely flat to make sufficient physical contact with the glass for the RTD temperature measurements to be accurate—with a reduction in the contact area between the pan and the glass, the glass temperature does not accurately reflect the pan temperature; and
Metal cooking vessels deform slightly at temperature above 300° F., reducing contact area between the cooking vessel and the glass cooking surface and making accurate temperature measurement using an RTD alone extremely unreliable. Likewise, use of any other method that measures only the temperature of the glass and which attempts to infer or calculate the temperature of a cooking vessel on top of glass based solely on glass temperatures will encounter the same inaccuracies at elevated temperatures (e.g. above 300° F.).

Since most cooking is done at temperatures in excess of 300° F., it is desirable to have a method by which cooking vessel temperature can be accurately measured and controlled. Present temperature measurement methods which use RTD readings alone (which measure the temperature of the glass cooking surface and not the cooking vessel) do not provide sufficient control over the temperature of the cooking vessel and thus are not conducive to cooking applications. Given the lack of accurate temperature control, typical control algorithms for inductive cooking systems allow for significant temperature overshoot when trying to obtain the response times required by many cooking applications. That is, in an attempt to quickly heat a food item (e.g. a pot of liquid such as soup), typical control algorithms will apply a high level of heat until the glass temperature reaches a desired level. However, given the delay or lag in the glass temperature relative to the pan temperature as well as a possible additional lag time due to the response time of the contact-based temperature sensing device, the pan in many cases will have exceeded the desired temperature by the time the temperature sensing mechanisms actually detect that the glass has reached the desired temperature. Nonetheless, this overshoot can be reduced, if not eliminated, by combining the use of an RTD with infrared temperature sensor measurements as disclosed herein.

Heated objects emit energy in the form of infrared radiation (light with wavelength ranging generally from 0.75 μm to about 15 μm) and thus measuring infrared energy can be used to determine the temperature of an object from a distance without making contact with the object. However, the poor transmissive properties of glass in the infrared spectrum have so far prevented the use of infrared (IR) energy-based sensing as a sole modality for measuring the temperature of a cooking or warming vessel (i.e. generally, but not exclusively, made of ferromagnetic materials) typically used in induction cooking surfaces. To the extent that IR temperature sensing has been used in induction cooking systems, this has involved creating a hole in the glass cooking surface and filling the hole with a material that is transparent to IR energy. This technique allows for reasonable temperature sensing for systems that are restricted for use at lower heating temperatures (<250° F.) because systems that are limited to operating in this low temperature range can simply use tempered glass, which is capable of withstanding the presence of the hole.

However, for applications in which a cooking temperature greater than 250° F. is desired, ceramitized glass is desirable because it provides the low thermal expansion and thermal shock resistance required for use at such elevated temperatures. For a cooking surface that is intended to be used at temperatures above 250° F., it is not possible to place a “window” of alternate material (i.e. material that is transparent to IR wavelengths) in ceramitized glass and still maintain the required material strength (i.e. prevent the glass from breaking during standardized impact tests). Therefore, the IR sensor must “view” the thermal load through the ceramitized glass (instead of through an IR-transparent window), the transmissivity of which varies according to wavelength and which is limited in certain wavelength ranges. That is, the ceramitized glass affects the transmissivity of IR energy, which adversely affects the accuracy of temperature calculations based on IR readings.

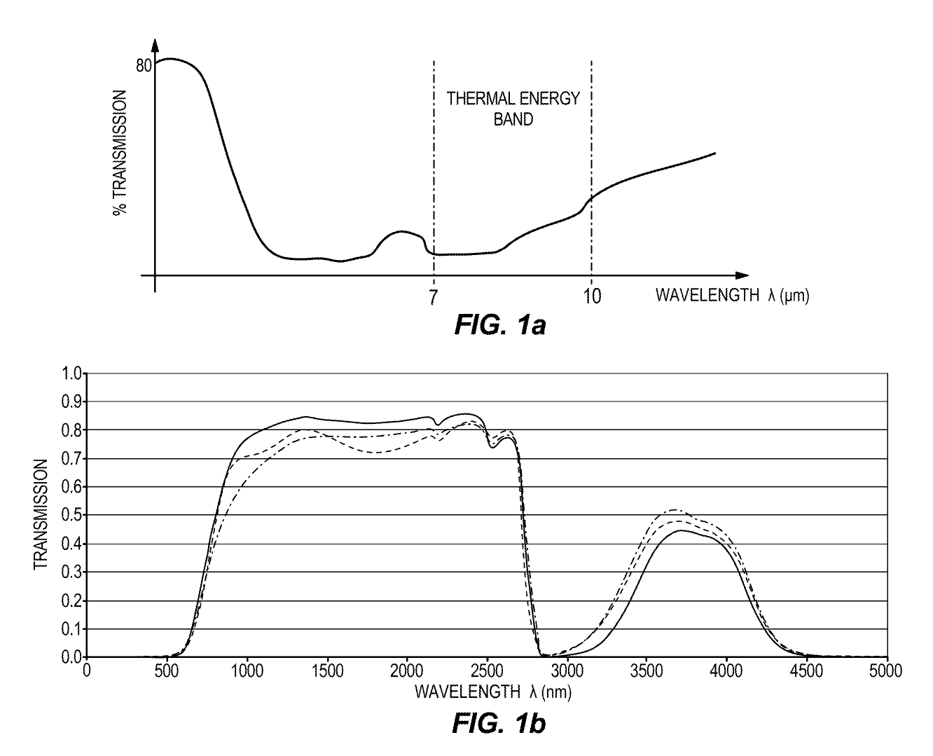

FIG. 1a shows the percent transmission of IR energy through ceramitized glass as a function of wavelength. FIG. 1a includes two vertical dashed lines which indicate the range of IR wavelengths at which peak thermal energy transmission occurs (“thermal energy band”), showing that the percent transmission in this range is relatively low. As seen in FIGS. 1a and 1b, there is a significant difference in transmission of infrared energy through the ceramitized glass at different wavelengths. In particular, within the thermal energy band at which most of the IR energy is emitted in an induction cooktop system, there is a significant increase in transmissivity from 7 μm to 10 μm. FIG. 1b shows transmission (fractionalized from 0.0-1.0) through three types of ceramitized glass with 4 mm thickness, in a wavelength range of 0 nm to 5000 nm (5 μm). Since it is known that the wavelength at which most of the IR energy is emitted changes as a function of object temperature, the amount of energy that is transmitted (i.e. due to the differences in transmissivity) through the glass varies as the temperature of the object changes. As a result, IR-based calculations of cooking vessel temperature may be inaccurate due to the differences in IR transmissivity of the ceramitized glass at different wavelengths. Therefore, in some embodiments a correction may be made in the estimated pan temperature to account for different levels of IR energy transmission. In one embodiment, a transfer function will be generated which translates IR sensor readings to pan temperatures. The transfer function will be based on a series of tests run with cookware of typical materials covering the majority of pans used with induction cooking systems. During the tests, the temperature of the pan will be directly monitored by external means such as direct contact temperature measurement. The IR sensor temperature reading will be correlated to the temperature obtained through direct contact and a transfer function will be created that will take the temperature determined using the IR sensor and translate it to a more accurate estimate of the pan temperature. In one particular embodiment, the transfer function will be a piecewise linear approximation and will include a multiplier that will be a function of the raw measured IR temperature.

An IR sensor for monitoring temperature in an induction heating system is located below the glass cooking surface and collects IR energy from the cooking vessel and the glass, as the glass is heated by the cooking vessel. Given the relatively small amount of IR energy emitted by cooking vessels at lower temperatures and the relatively low percent transmission in the thermal energy band, the amount of IR energy transmitted through the ceramitized glass is very low when the cooking vessel temperature is less than about 200° F. Thus, at low temperatures (e.g. 200° F.), most of the IR energy collected by the IR sensor is from the glass and only a small amount from the cooking vessel. This makes obtaining an accurate temperature calculation of the cooking vessel through ceramitized glass difficult at temperatures below 200° F. using IR readings. With increasing cooking vessel temperatures, however, the amount of IR energy that is transmitted through the ceramitized glass increases as a direct function of the cooking vessel temperature. At temperatures of 250° F. and above, the amount of thermal (IR) energy that is transmitted through the ceramitized glass from the heated cooking vessel shifts towards wavelength ranges having a greater percentage of transmission through the glass (e.g. towards the 10 μm wavelength range, see e.g. FIG. 1a). Thus, the IR energy emitted from the cooking vessel and transmitted through the glass becomes a more significant component of the energy that is collected by the IR sensor as temperatures increase. In some cases this can cause the IR sensor reading to lead to a temperature estimate that is slightly higher than the estimate based on the glass temperature alone. Nevertheless, if one knows the temperature of the glass cooking surface, the amount of energy released by the cooking surface and collected by the IR sensor can be calculated and subtracted from the IR sensor readings in order to determine the amount of sensed IR energy that is due to the cooking vessel alone.

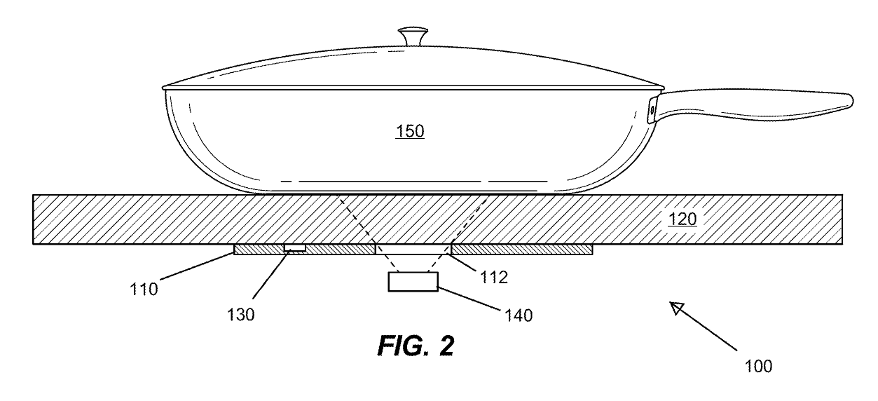

Accordingly, FIG. 2 shows a diagram of a dual mode temperature sensing system 100 for use in induction cooking. The system 100 includes an induction coil 110, a non-ferromagnetic cooking surface 120 (e.g. ceramitized glass which may be 4-6 mm thick), a contact-based temperature sensing device 130 (e.g. a resistive temperature device), and a non-contact (e.g. infrared-based) temperature sensing device 140 (sometimes referred to as an IR sensor). The contact-based temperature-sensing device 130, which may be a resistive temperature device (RTD), as known to those skilled in the art, is typically located on the underside of the non-ferromagnetic (e.g. glass) cooking surface 120 in the region of the induction coil 110 and provides an electrical value (e.g. resistance in ohms) which can be converted to a temperature. In certain embodiments, a suitable RTD may be selected from the VISHAY PTS series (Vishay Intertechnology, Inc., Malvern, Pa.). In general, RTDs are wire wound or thin film devices in which resistance increases as temperature increases (typically measured as a change in voltage across the RTD). Other contact-based temperature sensing devices 130 that could be used include thermocouples or thermistors.

The non-contact (e.g. infrared-based) temperature sensing device 140 is located under the cooking surface 120 (e.g. within the area circumscribed by the induction coil 110) and is positioned to collect IR energy emitted by the cooking surface 120 and any items that are on the cooking surface 120. In certain embodiments the induction coil 110 is designed so that it includes an opening 112 through which the non-contact (e.g. IR) temperature sensing device 140 can “see” the energy being emitted from a cooking vessel 150 placed on the cooking surface 120. In one embodiment, the non-contact (e.g. IR) temperature sensing device 140 has a conical field of view (e.g. at a 15° angle) aimed at the underside of the cooking surface 120. In various embodiments, the non-contact (e.g. IR) temperature sensing device 140 detects IR energy from a circle of approximately 1.25 inches in diameter near the center of the induction coil 110. Given that the non-ferromagnetic (e.g. glass) cooking surface 120 is relatively thin (e.g. 4-6 mm), the area of the cooking vessel 150 from which the non-contact (e.g. IR) temperature sensing device 140 receives energy is also a circle having a diameter of about 1.25 inches. One or more of the induction coil 110, the non-contact (e.g. IR) temperature sensing device 140, the contact-based temperature-sensing device 130, and a user interface may be operatively connected to a controller which carries out the operations disclosed herein.

In use, a cooking vessel (e.g. a pan), typically made of a ferromagnetic material, is placed on the cooking surface and is heated by magnetic induction from the induction coil. As the cooking vessel is heated, some of the heat of the cooking vessel is transferred to the cooking surface by conductive heat transfer, the efficiency of which depends on the amount of contact between the cooking vessel and the cooking surface. The heated cooking vessel and cooking surface both emit IR energy which is collected by the IR sensor. As shown in FIGS. 1a and 1b, however, transmission of IR energy through a cooking surface made of ceramitized glass is relatively inefficient, insofar as transmission is less than 50% for most IR wavelengths.

The total energy detected by the IR sensor (E_{Total}) shown in the arrangement in FIG. 2 can be expressed as shown in equation (1):

E_{Total}=E_{Pan}+E_{Glass} (1)

where E_{Pan} is the thermal radiation energy of the cooking vessel that is transmitted through the ceramitized glass and E_{Glass} is the thermal radiation energy emitted by the glass itself.

The energy measured by the IR sensor (E_{Total}) has two components, one contributed by the pan (E_{Pan}) and the other by the glass (E_{Glass}). The RTD sensor tracks the temperature of the glass. Glass temperature readings can be used to determine E_{Glass} and thus will account for the energy contributed to the IR sensor measurement from the glass. Therefore, it is possible to calculate the temperature of the pan by measuring the total energy received by the IR sensor, subtracting the energy contributed by the glass, and calculating pan temperature from the amount of energy emitted by the pan and collected by the IR sensor.

In various embodiments, the disclosed methods are suitable for use at a wide range of temperatures, including temperatures over 200° F., and are particularly well suited for use at temperatures above 225° F. For temperatures below 200° F., it is possible to use the RTD as the sole temperature sensor since the amount of IR energy transmitted from the pan through the glass is often too low to allow reliable IR sensor measurement of the pan temperature. Nevertheless, testing by the present inventors has shown that using the IR sensor to monitor glass temperatures below 200° F. provides reliability improvements over the use of the RTD alone. In particular, direct sensing of the glass temperature by the IR energy sensor at temperatures below 200° F. provides a faster response time to changes in the glass temperature since the lag time due to the response of the contact-based temperature sensing device is not present. In addition, at temperatures below 200° F. virtually all of the energy received by the IR sensor is from the glass itself and little or none is from the pan: the ratio of IR energy from the glass to IR energy from the pan in this temperature range varies from 20:1 to 40:1, so less than 5% of the IR energy below 200° F. is from the pan. Therefore, at these lower temperatures it is possible to calculate the glass temperature based on the IR energy readings. Accordingly, even at temperatures below 200° F. the combined sensor system disclosed herein offers advantages over known systems.

Thus, by combining the signals from two sensors—an RTD temperature sensor and an IR energy sensor—one can correct for the presence of a ceramitized glass cooking surface and accurately measure pan temperature at a broad range of temperatures. This allows for accurate monitoring and control of cooking vessel temperatures over a wide range, including temperatures above 300° F. that are often used in cooking applications. This level of temperature control has not previously been achieved in other systems, particularly at higher temperatures.

Combining information from the RTD sensor and the IR sensor provides at least two advantages. A first advantage is that the presence of both sensors allows for a calibration of the pan temperature, as described below, which permits the system to compensate for widely varying levels of emissivity of cookware. A second advantage is that using a combination of sensors allows for compensation for the effect of the ceramitized glass temperature when measuring at temperatures above approximately 250° F. In particular, the ability to subtract out the energy radiated by the ceramitized glass from the total energy measured by the IR sensor enables an accurate determination of the pan temperature, even at elevated temperatures at which RTD measurements alone are far less accurate.

Emissivity Calibration

When heating a cooking vessel (e.g. a pan) to a temperature above 250° F., the pan temperature and glass temperature will initially track one another well (i.e. are approximately equal) up to about 200° F., although the pan often reaches a given temperature before the glass does since the glass is heated indirectly by absorbing heat from the pan. Up to temperatures of approximately 200° F., the IR sensor receives only a small amount of energy from the pan that is transmitted through the glass. As discussed above, using the glass temperature that is obtained from the RTD sensor measurement allows one to subtract out the amount of energy contributed by radiation from the glass to determine the amount of energy from the pan. Using this information allows calculation of an estimated pan temperature which, at an RTD-measured glass temperature of 200° F., is expected to be equal to or slightly greater than 200° F. However, if the estimated pan temperature is below 200° F. when the RTD-measured glass temperature is 200° F., then this anomalously low estimated pan temperature is taken as an indication that the pan is made of a shiny material which has a relatively low emissivity. While only a small amount of IR energy collected by the IR sensor at about 200° F. is from the cooking vessel (less than 5%), this is sufficient to obtain an estimate of the cooking vessel temperature.

Pans with low emissivity emit less IR energy at a given temperature than pans with high emissivity. The emissivity of most pans falls into one of two basic ranges—for shiny pans, typical emissivity values of around 0.6 have been measured, while non-shiny cookware has emissivity values between 0.92 and 1. Therefore, to compensate for differences in emissivity of the cooking vessel, an emissivity value of 0.6 is used and appropriate adjustments are made to the temperature calculations when the estimated pan temperature is below 200° F. when the glass temperature is 200° F., as discussed below. In various embodiments, other emissivity values can be used other than 0.6 when the estimated pan temperature is lower than expected. In some embodiments, a different emissivity value is used when the estimated pan temperature is higher than the RTD-measured glass temperature (e.g. for a standard pan), for example an emissivity value of 0.92. Using one or both of these emissivity correction values improves the accuracy of the IR measurement for all temperatures above the calibration point (e.g. 200° F.).

Conversion Between Energy Values and Temperatures

Equation (2) is a modified form of the equation (1):

E_{Measured}=τE_{Pan}+E_{Glass} (2)

where E_{Measured} is the energy measured by the IR sensor, E_{Pan} is the energy radiated by the pan, E_{Glass} is the energy radiated by the glass and τ is the transmissivity of the glass (e.g. as shown in FIGS. 1a and 1b). Thus, compared to equation (1), equation (2) includes a factor τ to account for the fact that only a fraction of the energy emitted by the pan is transmitted through the glass to the IR sensor.

The IR sensor data can be used to compute a temperature based on the thermal energy that is detected, where thermal energy is proportional to the temperature measured to the fourth power. Radiated energy, in its simplest form is

E=σT⁴ (3)

where σ is the well-known Stefan-Boltzmann constant and T is the temperature of the radiating object.

Each of the energies in equation (2) can be represented by this temperature relationship. Thus, equation (2) becomes:

σT_{Measured}⁴=τσT_{Pan}⁴+σT_{Glass}⁴ (4)

Solving the above for T_{Pan} yields:

$${T}_{Pan} = \sqrt[4]{\frac{{T}_{Measured}^{4} - {T}_{Glass}^{4}}{τ}} \qquad ( 5 )$$

Therefore, the temperature of the pan is calculated using the measured temperature from the IR sensor (T_{Measured}, which can be computed from the measured energy, E_{Measured}, using equation (3)), the glass temperature (T_{Glass}, which can be computed from the RTD or other contact sensor readings), and the transmissivity of the glass τ. In some embodiments, the calculations of equation (5) including the determination of the fourth root may be performed using lookup tables.

Equation (3) assumes that the body that is radiating energy is a black body which has an emissivity of 1.0. However, as discussed above many pans have emissivity values less than 1.0 and certain types (e.g. shiny pans) have relatively low emissivity values around 0.6. Thus, an object with less than perfect emissivity (i.e. an object that does not exhibit black body radiation behavior) will emit less energy than expected at a given temperature and therefore calculated temperatures will be underestimates of the actual temperature of the body. Therefore, to correct for emissivity of the cooking vessel, the temperature that is calculated in equation (5) may be divided by an emissivity correction factor. As described above, the emissivity correction factor in some embodiments may be set to 0.6 for pans that are determined to have particularly low emissivity (e.g. due to an anomalously low estimated temperature at about 200° F.). In other embodiments the temperature determined in equation (5) may be divided by an emissivity correction factor of 0.92 when it is determined that the cooking vessel has a relatively high emissivity. In either case, dividing by the emissivity correction factor will increase the final calculated temperature since the factor is less than 1.

Various features and advantages of the invention are set forth in the following claims.

What is claimed is:

1. An inductive cooking system, comprising:
a non-ferromagnetic cooking surface;
an induction coil disposed adjacent to the cooking surface;
a contact-based temperature sensing device thermally coupled to the cooking surface; and
a non-contact temperature sensing device positioned to collect heat energy from an underside of the cooking surface.

2. The induction cooking system of claim 1, wherein the contact-based temperature sensing device is thermally coupled to the cooking surface within a region defined by the induction coil.

3. The induction cooking system of claim 1, wherein the non-contact temperature sensing device is positioned to collect heat energy from the cooking surface within a region defined by the induction coil.

4. The induction cooking system of claim 1, wherein the non-contact temperature sensing device comprises an infrared-based temperature sensing device.

5. The inductive cooking system of claim 4, further comprising a controller operatively connected to the contact-based temperature sensing device and the infrared-based temperature sensing device, wherein the controller
collects a measurement from the contact-based temperature sensing device and determines a cooking surface temperature based on the measurement;
collects an amount of infrared energy from the infrared-based temperature sensing device,
calculates an amount of energy emitted by the cooking surface based on the cooking surface temperature,
subtracts the amount of energy emitted by the cooking surface from the amount of infrared energy to determine an amount of energy transmitted through the cooking surface, and
determines a calculated temperature associated with the amount of energy transmitted through the cooking surface.

6. The induction cooking system of claim 5, wherein the energy transmitted through the cooking surface originates from a cooking vessel adjacent to the cooking surface.

7. The induction cooking system of claim 6, wherein the controller determines an adjusted temperature associated with the amount of energy transmitted through the cooking surface using an emissivity correction factor for the cooking vessel.

8. The induction cooking system of claim 7, wherein, if the calculated temperature is less than the cooking surface temperature, the emissivity correction factor is set to a low emissivity correction factor value.

9. The induction cooking system of claim 8, wherein the low emissivity correction factor value is 0.6.

10. The induction cooking system of claim 7, wherein, if the calculated temperature is greater than the cooking surface temperature, the emissivity correction factor is set to a high emissivity correction factor value.

11. The induction cooking system of claim 10, wherein the high emissivity correction factor value is 0.92.

12. The induction cooking system of claim 7, wherein the controller divides the calculated temperature by the emissivity correction factor to determine the adjusted temperature.

13. The induction cooking system of claim 1, wherein the cooking surface comprises ceramitized glass.

14. A method of inductive cooking using an inductive cooking system, the inductive cooking system including a non-ferromagnetic cooking surface and an induction coil disposed adjacent to the cooking surface, the method comprising the steps of:
obtaining a measurement from a contact-based temperature sensing device thermally coupled to the cooking surface; and
obtaining a measurement from a non-contact temperature sensing device positioned to collect heat energy from an underside of the cooking surface.

15. The method of claim 14, wherein obtaining a measurement from a contact-based temperature sensing device comprises obtaining a measurement from a contact-based temperature sensing device from within a region defined by the induction coil.

16. The method of claim 14, wherein obtaining a measurement from a non-contact temperature sensing device comprises obtaining a measurement from a non-contact temperature sensing device from within a region defined by the induction coil.

17. The method of claim 14, wherein the non-contact temperature sensing device comprises an infrared-based temperature sensing device and wherein obtaining a measurement from a non-contact temperature sensing device comprises obtaining a measurement from the infrared-base temperature sensing device.

18. The method of claim 17, further comprising the steps of
determining a cooking surface temperature based on the measurement obtained from the contact-based temperature sensing device;
determining an amount of infrared energy based on the measurement obtained from the infrared-based temperature sensing device,
calculating an amount of energy emitted by the cooking surface based on the cooking surface temperature,
subtracting the amount of energy emitted by the cooking surface from the amount of infrared energy to determine an amount of energy transmitted through the cooking surface, and
determining a calculated temperature associated with the amount of energy transmitted through the cooking surface.

19. The method of claim 18, wherein the energy transmitted through the cooking surface originates from a cooking vessel adjacent to the cooking surface.

20. The method of claim 19, further comprising determining an adjusted temperature associated with the amount of energy transmitted through the cooking surface using an emissivity correction factor for the cooking vessel.

21. The method of claim 20, wherein, if the calculated temperature is less than the cooking surface temperature, the method further comprises setting the emissivity correction factor to a low emissivity correction factor value.

22. The method of claim 21, wherein the low emissivity correction factor value is 0.6.

23. The method of claim 20, wherein, if the calculated temperature is greater than the cooking surface temperature, the method further comprises setting the emissivity correction factor to a high emissivity correction factor value.

24. The method of claim 23, wherein the high emissivity correction factor value is 0.92.

25. The method of claim 20, further comprising dividing the calculated temperature by the emissivity correction factor to determine the adjusted temperature.

26. The method of claim 14, wherein the cooking surface comprises ceramitized glass.
